(19) United States
(12) Patent Application Publication
(10) Pub. No.: US 2024/0198735 A1
(43) Pub. Date: Jun. 20, 2024

(54) TIRE FOR PASSENGER VEHICLE

(71) Applicant: COMPAGNIE GENERALE DES ETABLISSEMENTS MICHELIN, Clermont-Ferrand (FR)

(72) Inventors: SOPHIE GANDER, Clermont-Ferrand (FR); GAEL ROTY, Clermont-Ferrand (FR)

(21) Appl. No.: 18/286,508

(22) PCT Filed: Apr. 4, 2022
(86) PCT No.: PCT/FR2022/050622

§ 371 Date: Oct. 11, 2023

(30) Foreign Application Priority Data
Apr. 12, 2021 (FR) 2103760

(51) Int. Cl. B60C 15/06; B60C 1/00

(52) U.S. Cl. CPC B60C 15/0607; B60C 2001/0058; B60C 2015/061; B60C 2015/065; B60C 2015/0678

(57) ABSTRACT

A tire (1) for a passenger vehicle exhibits improved performance in terms of rolling resistance without adversely affecting the transverse cornering stiffness. The bead (50) comprises a filler layer (70) and a lateral reinforcing layer (60) is made more flexible by the use of low-hysteresis materials. The transverse cornering stiffness is increased by managing the contact between the bead (50) and the mounting rim (100). In a first section located in the contact patch, in at least a first bead, the length of the rim contact curve, LADC, is measured. In a second section located opposite the contact patch in relation to the axis of rotation of the tire, in at least a second bead, the length of the rim contact curve, LCJ, is measured. The ratio of the difference in the lengths, i.e. 100*(LADC−LCJ)/LCJ, is greater than or equal to 30.

### FIELD OF THE INVENTION

The present invention relates to a tyre for a motor vehicle of which the performance in terms of rolling resistance is improved without adversely affecting the transverse cornering stiffness. The invention is more particularly suited to a radial tyre intended to be fitted to a passenger vehicle or a van.

### Definitions

By convention, consideration is given to a frame of reference (O, XX′, YY′, ZZ′), the centre O of which coincides with the centre of the tyre, the circumferential direction XX′, axial direction YY′ and radial direction ZZ′ refer to a direction tangential to the tread surface of the tyre in the direction of rotation, to a direction parallel to the axis of rotation of the tyre, and to a direction orthogonal to the axis of rotation of the tyre, respectively.

Radially inner and radially outer mean closer to and further away from the axis of rotation of the tyre, respectively.

Axially inner and axially outer mean closer to and further away from the equatorial plane of the tyre, respectively, the equatorial plane of the tyre being the plane that passes through the middle of the tread of the tyre and is perpendicular to the axis of rotation of the tyre.

The makeup of the tyre is usually described by a representation of its constituent components in a meridian plane, that is to say a plane containing the axis of rotation of the tyre.

A tyre comprises a crown intended to come into contact with the ground via a tread, the two axial ends of which are connected via two sidewalls to two beads that provide the mechanical connection between the tyre and the rim on which it is intended to be mounted.

A radial tyre also comprises a reinforcement made up of a crown reinforcement radially on the inside of the tread and a carcass reinforcement radially on the inside of the crown reinforcement.

The crown reinforcement of a radial tyre comprises a superposition of circumferentially extending crown layers radially on the outside of the carcass reinforcement. Each crown layer is made up of reinforcers that are mutually parallel and coated in a polymeric material of the elastomer or elastomeric compound type. The assembly made up of the crown reinforcement and the tread is referred to as the crown.

The carcass reinforcement of a radial tyre usually comprises at least one carcass layer made up of metal or textile reinforcing elements that are coated in an elastomeric coating compound. The reinforcing elements are substantially mutually parallel and form an angle of between 85° and 95° with the circumferential direction. The carcass layer comprises a main part which joins the two beads together and is wrapped, in each bead, around an annular reinforcing structure. The annular reinforcing structure may be a bead wire which comprises a circumferential reinforcing element, which is usually made of metal and is surrounded by at least one elastomeric or textile material, those materials not being exhaustive. The carcass layer is wrapped around the annular structure from the inside towards the outside of the tyre to form a turn-up comprising an end. The turn-up, in each bead, allows the carcass reinforcement layer to be anchored to the annular structure of the bead.

Each bead comprises a filler layer that extends the annular reinforcing structure radially outwards. The filler layer consists of at least one elastomeric filler compound. The filler layer axially separates the main part and the turn-up of the carcass reinforcement.

Each bead also comprises a protective layer which extends the sidewall radially inwards and is axially on the outside of the turn-up. The protective layer is also at least partially in contact, via its axially outer face, with a flange of the rim. The protective layer consists of at least one protective elastomeric compound.

Lastly, each bead comprises a lateral reinforcing layer positioned between the sidewall and the turn-up of the carcass reinforcement. The outer lateral reinforcing layer consists of at least one elastomeric compound.

Each tyre sidewall comprises at least one sidewall layer consisting of an elastomer compound and extending axially towards the inside of the tyre from an outer face of the tyre, in contact with the atmospheric air.

The term “radial cross section” or “radial section” is understood here to mean a cross section or a section along a plane which contains the axis of rotation of the tyre.

An elastomeric compound is understood to mean an elastomeric material obtained by blending its various constituents. An elastomeric compound conventionally comprises an elastomer matrix comprising at least one diene elastomer of the natural or synthetic rubber type, at least one reinforcing filler of the carbon black type and/or of the silica type, a crosslinking system that is usually sulfur-based, and protective agents. For some applications, the elastomers in question may also comprise thermoplastics (TPE).

The expression “composition based on” should be understood to mean a composition including the compound and/or the reaction product of the various constituents used, some of these base constituents being capable of reacting or intended to react with one another, at least in part, during the various phases of manufacture of the composition, in particular in the course of crosslinking or vulcanizing it.

The expression “proportion by weight per hundred parts by weight of elastomer” (or phr) should be understood to mean, within the meaning of the present invention, the proportion by weight per hundred parts of elastomer present in the compound composition under consideration.

An elastomeric compound can be mechanically characterized, in particular after curing, by its dynamic properties, such as a dynamic shear modulus G*=(G′2+G″2)1/2, where G′ is the elastic shear modulus and G″ is the viscous shear modulus, and a dynamic loss Tan δ=G″/G′. The dynamic shear modulus G* and the dynamic loss Tan δ are measured on a Metravib VA4000 viscosity analyser in accordance with the standard ASTM D 5992-96. The response of a sample of vulcanized elastomeric compound in the form of a cylindrical test specimen with a thickness of 4 mm and a cross section of 400 mm², subjected to a simple alternating sinusoidal shear stress, at a frequency of 10 Hz and at a temperature of 100° C., is recorded. A strain amplitude sweep is carried out from 0.1% to 50% (outward cycle) and then from 50% to 0.1% (return cycle). For the outward cycle, the maximum value of tan(δ) observed, denoted Tan(δ)ₘₐₓ, is indicated.

The “handling” performance corresponds to the responses of a vehicle/tyre assembly to multiple stresses caused by the driver (steering, acceleration, braking, etc.). Handling is essential both in terms of safety, for the stability of the vehicle, and for driving pleasure.

The tyre plays a key role in handling since it ensures, at the end of the chain, the transmission of forces between the vehicle and the ground in order to maintain the trajectory defined by the driver.

During cornering, in order for the vehicle to stay on a trajectory, it is necessary to generate a force which is equivalent (but in the opposite direction) to the centrifugal force, which tends to move the vehicle away from the trajectory. This lateral force must be generated by the 4 tyres of the vehicle to overcome the centrifugal force.

The deformation of the blocks of rubber in contact with the ground generates a lateral force. The mechanism allowing the tyre to deform the blocks of rubber during cornering is drifting. Drift is the angle between the direction of the wheel and the trajectory followed by the vehicle. During cornering, this angle is not zero in order to allow the tyre to deform the blocks of rubber of the tread and thus generate the required lateral forces.

Transverse cornering stiffness refers to the variation in transverse forces generated in the contact patch of the tyre when moving in a manner compressed by the load carried, as a function of the drift angle applied to the tyre. The transverse cornering stiffness is expressed in newtons per degree)(N/°).

For small drift angles, that is to say angles less than 10°, the transverse force, which is in a direction parallel to the axis of rotation of the tyre, is proportional to the drift angle. The transverse cornering stiffness is equal to this coefficient of proportionality.

The transverse cornering stiffness is an essential physical variable which links the tyre to the vehicle and determines the quality of the handling of the vehicle on the road.

Rolling resistance is another performance dealt with in the invention. The rolling resistance is one of the forces opposing the forward travel of the vehicle. The coefficient of rolling resistance of a tyre (C_{RR}) is the rolling resistance force relative to the load carried by the tyre. The coefficient is expressed in kg/t.

The rolling resistance is essentially linked to the deformation of the tyre. By way of illustration, the beads associated with the sidewalls represent 20% to 30% of the rolling resistance of the tyre, whereas the tread contributes 60% to 80%.

Most often in the invention, the tyre is mounted on a rim. This rim is selected in accordance with the specifications of the ETRTO (European Tyre and Rim Technical Organization) standard, which associates recommended rims with a given tyre size. In general, multiple rim widths may be suitable for one and the same tyre size. That part of the rim that interacts with the tyre within the context of the invention exhibits symmetry of revolution about the axis of rotation of the tyre. To describe the rim, it is sufficient to describe the generator profile in a meridian plane.

In a meridian plane, the rim comprises at least one flange located at one axial end and connected to a seat which is intended to receive a radially innermost face of the bead. A rectilinear portion which connects the rim flange to the seat via fillets is between the seat and the flange. The flange of the rim continued by the rectilinear portion axially limits the movement of the beads during inflation.

The mountability of the beads on a rim during inflation is also a performance on which the invention has an impact. The performance in terms of mountability of the beads consists in evaluating the ability of the beads of a tyre to be installed correctly on a rim during inflation. On the radially innermost face of the bead, there must be sufficient contact with the seat to avoid any leakage of the air used to inflate the tyre. In general, a contact pressure of at least 1.4 MPa is expected in this contact area. The inflation pressure traps the bead against the flange of the rim. The contact pressure on the flange must also be sufficient to avoid the tyre coming off of the rim, notably during tight cornering at high speed. Observation means, which notably operate by radiography, for observing the beads mounted on a rim make it possible to diagnose the quality of the mounting.

It is therefore possible to classify two tyres with respect to their performance in terms of mountability on a rim.

### PRIOR ART

Reducing greenhouse gas emissions in the field of transport is one of the major challenges facing vehicle manufacturers today. A great deal of progress has been made through tyres by lowering the rolling resistance, because this has a direct impact on the fuel consumption of the vehicle. By way of illustration, a 20% drop in the rolling resistance of a tyre makes it possible to save approximately 3% fuel per 100 km over a combined cycle.

There is still a need to reduce the rolling resistance of tyres for passenger vehicles without adversely affecting their handling on the vehicle.

It has already been proposed to improve the rolling resistance of tyres for passenger vehicles by optimizing their beads. Document WO 2010/072736 notably teaches the use of elastomeric compositions with low elastic moduli G′ of around 15 MPa and viscous moduli G″ that are more than 20% lower than the elastic moduli to obtain a notable drop in the rolling resistance.

That document also recommends reducing the rolling resistance even further by optimizing the geometry of the layers of elastomeric compound of which the elastic and viscous moduli satisfy the above relationship. This optimization leads to profiles of layers of elastomeric compounds which are shorter and wider than in traditional tyres, and can cause implementation difficulties.

Document FR2994127 describes an improvement to document WO 2010/072736 with the preposition of adding a reinforcement in the beads. The reinforcement is formed by reinforcers that are coated in an elastomeric compound.

The major drawback of this solution is a significant increase in the industrial manufacturing cost with the introduction of new semifinished products into the process for manufacturing the tyre.

The inventors have set themselves the aim of producing a tyre which improves the rolling resistance without adversely affecting the handling of the vehicle, while still controlling the related manufacturing costs.

### DISCLOSURE OF THE INVENTION

This aim has been achieved by a tyre for a passenger vehicle, comprising: two beads intended to be mounted on a rim, two sidewall layers connected to the beads, and a crown having a tread intended to come into contact with the ground, the crown having a first side connected to the radially outer end of one of the two sidewall layers and a second side connected to the radially outer end of the other one of the two sidewall layers;
at least one carcass reinforcement extending from the two beads through the sidewall layers as far as the crown, the carcass reinforcement having a plurality of carcass reinforcing elements and being anchored in the two beads by way of a turn-up around the annular reinforcing structure, so as to form a main part and a turn-up in each bead;
a first layer of elastomeric filler compound taking up a volume which is comprised at least partially on the one hand between the main part of the carcass reinforcement, and on the other hand the radially outer portion of the annular reinforcing structure, and extending radially outwards to an end located at a normal distance DRB from the axial straight line HH′ which is tangent to the annular reinforcing structure at its radially innermost point;
a second layer of elastomeric compound forming a lateral reinforcing layer taking up a volume comprised at least partially between the sidewall layer and the turn-up of the carcass reinforcement, and extending radially outwards to an end located at a normal distance DRL from the axial straight line HH′ which is tangent to the annular reinforcing structure at its radially innermost point;
the dynamic shear stiffness moduli and the viscoelastic loss of the elastomeric compounds being measured in accordance with the standard ASTM D 5992-96, at 100° C., under 10% strain;
in each bead, a rim contact curve comprising the points on the tyre that are in contact with the rim, this rim contact curve connecting a first point M1 on the tyre that is positioned axially furthest on the outside, and in contact with the rim, and a second point M2 on the tyre which is also in contact with the rim and is located in the middle of the rectilinear portion connecting the flange to the seat of the rim; the length of this rim contact curve being the curvilinear distance from the point M1 to the point M2 along the contact curve;
two sections in a vertical meridian plane of the inflated tyre mounted on a rim and compressed against a hard flat ground, by a vertical load, wherein the load and the inflation pressure are at their nominal values from the ETRTO (European Tyre and Rim Technical Organization) standard; a first section being located in the contact patch, and a second section being located on the opposite side to the first in relation to the axis of rotation of the tyre;
in the first section located in the contact patch, in at least a first bead, the length of the rim contact curve, LADC, being measured;
in the second section located opposite the contact patch in relation to the axis of rotation of the tyre, in at least a second bead, the length of the rim contact curve, LCJ, being measured;
the ratio of the difference in the lengths of the rim contact curves in the two sections, i.e. 100*(LADC−LCJ)/LCJ, is greater than or equal to 30;
the viscoelastic loss Tan(δ)max of the elastomeric compound making up the second lateral layer of at least one bead has a value less than or equal to 0.100.

The ratio of the variation in rim contact, 100*(LADC−LCJ)/LCJ, of the tyres of the invention of greater than 30, combined with a level of hysteresis Tan(δ)max less than or equal to 0.100 of the elastomeric compound making up the second lateral reinforcing layer, lead to a drop in the rolling resistance of the tyre without adversely affecting the handling of the vehicle on which it is mounted. The bead of such a tyre realizes a balanced performance in terms of rolling resistance and transverse cornering stiffness by virtue of the material properties and the geometric profile of the sidewall layer in the area of contact with the rim. The manufacture of such a tyre does not require any particular development of the processes or the introduction of new materials, this keeping the industrial manufacturing cost unchanged in relation to the prior art.

The ratio of the variation in rim contact of the tyres of the invention is much greater than that found on the tyres of the prior art.

The rim contact curve represents all of the points on the tyre that are in contact with the rim at a given moment. For each of the beads, this rim contact curve extends from a first point M1 on the tyre that is positioned axially furthest on the outside, and in contact with the rim, and a second point M2 on the tyre that is also in contact with the rim and is located in the middle of the rectilinear portion connecting the flange to the seat of the rim. The length of this rim contact curve is the curvilinear distance from the point M1 to the point M2 along the rim contact curve.

When the inflated tyre, mounted on a rim, is compressed by a load that is carried, the points on the tyre that are in contact with the rim can vary from one meridian to another. It follows that the length of the rim contact curve as defined above also varies from one meridian to another.

The tyre is designed such that the rim contact curve is as long as possible in the contact patch, by comparison with the tyres of the prior art, and more specifically in the meridian at the centre of the contact patch. In these conditions, the inventors estimate that the contribution of the rim contact to the cornering stiffness is at its highest.

In a meridian section of an inflated tyre mounted on a rim and compressed by the load carried, it is possible to see a first section of the tyre which passes through the centre of the contact patch. Contact patch is understood to mean all of the points on the tyre which, at a given moment, are in contact with the ground against which the tyre is compressed. That point on the contact patch that is located on the vertical axis ZZ′ is referred to as centre of the contact patch. It is also possible to see, opposite the contact patch in relation to the axis of rotation YY′ of the tyre, another section of the tyre which overall defines a deformed state similar to the state of inflation exhibiting symmetry of revolution.

The ratio of the variation in the rim contact corresponds to the maximum value of the evolution of the rim contact lengths per wheel revolution.

According to the inventors, an essential step in designing the tyre of the invention consists in modifying its outer profile in the area of contact with the rim. Various solutions are possible, for example increasing the axial thickness of the sidewall layer at the join with the protective layer. Other solutions consist in modifying the outer profile so as to obtain a profile in the contact area having the same curvature as the rim flange. Yet another solution consists in inserting a cushion of compound in the area at the join between the sidewall layer and protective layer, at the flange of the rim. This cushion of compound may preferably consist of the same compound as that of the sidewall layer, so as to retain the industrial manufacturing cost. What is anticipated of this cushion of elastomeric compound is especially its elastic shear stiffness modulus, which advantageously could be for example equal to that of the sidewall layer.

According to the invention, the viscoelastic loss Tan(δ)max of the elastomeric compound making up the second lateral reinforcing layer of at least one bead has a value less than or equal to 0.100.

The invention proposes the use of a second lateral layer with a viscoelastic loss less than or equal to 0.100 with the aim of improving the rolling resistance. This second lateral reinforcing layer may be associated with the first filler layer which may also have a low viscoelastic loss, or be stiff, or else be flexible.

The function of the second lateral reinforcing layer in the bead is to reinforce the filler layer in terms of shear stiffnesses. The transmission of the vehicle torque to the wheel requires a bead with a sufficient level of stiffness to be effective. The second lateral reinforcing layer contributes to the stiffness of the bead by collaborating with the first filler layer.

The drop in rolling resistance of the bead consists in lowering the hysteresis of the elastomeric compounds that have the greatest volume and are subject to considerable strain. The first and second layers of compound of the bead that are positioned respectively axially on the inside and axially on the outside of the turn-up of the carcass reinforcement are those that take up the largest volume and undergo strong bending stresses, extension-compression stresses and shear stresses.

In a first advantageous embodiment, the second lateral reinforcing layer of at least one bead has an elastic shear stiffness modulus that lies within the range [1.5; 10] MPa, preferably within the range [1.5; 7] MPa.

This embodiment aims to make the bead work with a flexible second lateral reinforcing layer, whereas usually the lateral reinforcing layer has a shear stiffness modulus between 20 MPa and 50 MPa. This embodiment has the advantage of using an elastomeric compound having both a low viscoelastic loss, with Tan(δ)max less than 0.1, and at the same time an elastic shear stiffness modulus within the range [1.5; 10] MPa. It is not particularly difficult to implement such a compound considering the coherence of these material properties.

In a second advantageous embodiment of the invention, the viscoelastic loss Tan(δ)max of the elastomeric compound making up the first filler layer of at least one bead has a value less than or equal to 0.100.

In this embodiment, the compromise in performance is weighted towards the rolling resistance side. The volume of this first filler layer is the greatest of the bead. The drop in its hysteresis combined with a second lateral reinforcing layer with a low loss is manifested by a notable drop in the rolling resistance of the bead.

In other words, this embodiment is conducive to the drop in rolling resistance of the bead and thus of the tyre while still having a level of handling on a vehicle which is comparable to a tyre of the prior art by virtue of the ratio of the variation in the rim contact, which remains at a level greater than 30.

According to a third embodiment, the elastic shear stiffness modulus of the elastomeric compound making up the first filler layer of at least one bead lies within the range [1.5; 10] MPa, preferably within the range [1.5; 7] MPa.

Another advantage of the invention that is linked to this variant is that, when carrying out tests of mountability on a rim which compare the tyres of the prior art and of the invention, the inventors noted that the mountability of the tyres of the invention is better than some tyres having stiff beads. This is because, in the tyres of the prior art, the compound of the filler layer has an elastic stiffness modulus generally lying between 15 MPa and 50 MPa. The inventors hypothesize that the flexibility relative to the bead of the tyres of the invention makes it possible to facilitate mounting owing to their deformability, which promotes better installation on the seat, and against the rim flange. Moreover, the modification of the profile of the sidewall layer radially on the inside, associated with a stiff bead, causes a drop in mountability on a rim. The use of flexible elastomeric compounds (G′<10 MPa) makes it possible to compensate for this drop and obtain a suitable level of mountability.

Preferably, the ratio of the difference in the lengths of the rim contact curves of the two sections, i.e. 100*(LADC−LCJ)/LCJ, is greater than or equal to 40, preferably greater than or equal to 50, more preferably greater than or equal to 70.

The inventors have found that the transverse cornering stiffness of the tyre of the invention increases in the same sense as the ratio of the variation in rim contact. For such ratios of the variation in rim contact, the modification of the outer profile of the sidewall layer makes it easier to mount the bead, but excessive ratios higher than 100 could inhibit the mountability.

In addition to the main features of the invention, the inventors have identified the levers linked to the geometry of the layers of compounds of the bead for better managing the compromise in terms of performance of the tyre with improved rolling resistance while retaining good handling.

Advantageously, the radial distance DRB of the first filler layer comprised between the main part of the carcass reinforcement and its turn-up is less than or equal to 50% of the radial height H of the tyre.

The height H of the tyre is the normal distance between a first straight line which is parallel to the axis of rotation of the tyre and tangent to the radially innermost point of the annular reinforcing structure, and a second straight line which is also parallel to the axis of rotation of the tyre and passes through the radially outermost point of the tread. The radial height H is measured on the tyre mounted on a rim and inflated to a setpoint pressure in accordance with the ETRTO (European Tyre and Rim Technical Organization) specifications.

Advantageously, with the radial distance DRI being the radial height of a radially innermost end of the lateral reinforcing layer positioned between the sidewall layer and the turn-up of the carcass reinforcement, said radial distance DRI lies within the range [5%; 25%] of the radial height H of the tyre.

More advantageously, with the distance DRL being the distance of the radially outer end of the lateral reinforcing layer positioned between the sidewall layer and the turn-up of the carcass reinforcement, said distance DRL is greater than or equal to 25% of the radial height H of the tyre.

It will be recalled that the distance DRL is the normal distance from the radially outermost end of the end of the second lateral reinforcing layer to the straight line (HH′) which is tangent to the annular reinforcing structure at its radially innermost point.

The second lateral reinforcing layer comprised between the sidewall and the turn-up of the carcass reinforcement contributes to the stiffness of the additional bead in the first filler layer. According to the inventors, its positioning is regulated by the sides DRI and DRL so as to withstand bending stresses and extension-compression stresses of the bead when it enters the contact patch.

In an advantageous embodiment of the invention, the turn-up of the carcass reinforcement is in contact with the main part of the carcass reinforcement radially on the outside along the turn-up.

As mentioned above, the carcass reinforcement is formed of reinforcers coated between two layers of elastomeric compounds. That the turn-up of the carcass reinforcement is pressed against the main part of the carcass reinforcement means that the turn-up is in contact with the main arm of the carcass reinforcement. The contact is made along an axially outer surface of the coating of the carcass reinforcement.

In this configuration, the volume of the first filler layer is limited to a strict minimum around the annular reinforcing structure. This configuration is very advantageous for the drop in rolling resistance of the bead.

In another embodiment, a reinforcement of the bead is introduced axially between the turn-up of the carcass reinforcement and the lateral reinforcing layer, axially on the inside of the sidewall.

The reinforcement of the bead is formed of mutually parallel reinforcers coated between two layers of elastomeric compounds. The addition of this semi-finished product generates an additional manufacturing cost which must be compensated.

In order to limit the impact on the manufacturing cost of such a solution, this embodiment can be combined with the pressing of the turn-up of the carcass reinforcement against the main part of the carcass reinforcement.

Advantageously, the elastomeric compound making up at least one layer of the first and the second layer of at least one bead has a composition on the basis of 100% polyisoprene natural rubber, or else a blend of natural rubber and polybutadiene, a crosslinking system, a reinforcing filler of carbon black N550 type, at an overall content of between 50 and 75 phr.

Preferably, the elastomeric compound making up the filler layer of at least one bead has the same composition as the elastomeric compound making up the lateral outer reinforcing layer of the bead.

The rubber composition is preferably based on at least one diene elastomer, a reinforcing filler and a crosslinking system.

A “diene” elastomer (or equally rubber) is understood to mean, in the known way, an elastomer derived at least in part (i.e. a homopolymer or a copolymer) from diene monomers, that is to say monomers bearing two conjugated or unconjugated carbon-carbon double bonds. The diene elastomer used is preferably selected from the group consisting of polybutadienes (BRs), natural rubber (NR), synthetic polyisoprenes (IRs), styrene-butadiene copolymers (SBRs), butadiene-isoprene copolymers (BIRs), styrene-isoprene copolymers (SIRs), styrene-butadiene-isoprene copolymers (SBIRs) and the compositions of these elastomers.

A preferred embodiment consists in using an “isoprene” elastomer, that is to say an isoprene homopolymer or copolymer, in other words a diene elastomer selected from the group consisting of natural rubber (NR), synthetic polyisoprenes (IRs), the various copolymers of isoprene and the compositions of these elastomers.

The isoprene elastomer is preferably natural rubber or a synthetic polyisoprene of the cis-1,4 type. Of these synthetic polyisoprenes, use is preferably made of polyisoprenes that have a content (mol %) of cis-1,4 bonds greater than 90%, more preferably still greater than 98%. According to other preferred embodiments, the diene elastomer may consist, completely or partially, of another diene elastomer such as, for example, an SBR (E-SBR or S-SBR) elastomer which is used or not used in a blend with another elastomer, for example of the BR type.

The rubber composition may also contain all or some of the additives usually used in the rubber matrices intended for the manufacture of tyres, for example reinforcing fillers such as carbon black or inorganic fillers such as silica, coupling agents for inorganic fillers, anti-ageing agents, antioxidants, plasticizers or extender oils, whether the latter are of aromatic or non-aromatic nature (notably oils that are very weakly if at all aromatic, for example of the naphthene or paraffin oil type, of high or preferably low viscosity, MES or TDAE oils, plasticizing resins with a high Tg above 30° C.), agents that improve the workability (processability) of the compositions in the raw state, tackifying resins, a crosslinking system based either on sulfur or on sulfur and/or peroxide donors, accelerants, vulcanization activators or retardants, antireversion agents, methylene acceptors and donors, for example HMT (hexamethylenetetramine) or H3M (hexamethoxymethylmelamine), reinforcing resins (such as resorcinol or bismaleimide), known adhesion promoter systems of the metal salt type for example, notably cobalt or nickel salts.

The compositions are manufactured in appropriate mixers, using two successive preparation phases well known to those skilled in the art: a first phase of thermomechanical kneading or working (“non-productive” phase) at high temperature, up to a maximum temperature between 110° C. and 190° C., preferably between 130° C. and 180° C., followed by a second phase of mechanical working (“productive” phase) to a lower temperature, typically below 110° C., this being a finishing phase during which the crosslinking system is incorporated.

By way of example, the non-productive phase is carried out in a single thermomechanical step lasting a few minutes (for example between 2 and 10 min) during which all the necessary base constituents and other additives, except for the crosslinking or vulcanization system, are introduced into a suitable mixer such as a conventional internal mixer. After cooling the composition thus obtained, the vulcanization system is then incorporated in an external mixer, such as an open mill, kept at a low temperature (for example between 30° C. and 100° C.). The whole is then mixed (productive phase) for a few minutes (for example between 5 and 15 min).

The final composition thus obtained is subsequently calendered, for example in the form of a sheet or a slab for characterization, or else extruded, in order to form the outer band used in the tyre according to the invention.

The vulcanization (or curing) can subsequently be carried out in a known way at a temperature generally between 130° C. and 200° C., preferably under pressure, for a long enough time which can vary, for example, between 5 and 90 min depending notably on the curing temperature, the vulcanization system adopted and the vulcanization kinetics of the composition under consideration.

### BRIEF DESCRIPTION OF THE DRAWINGS

Further details and advantageous features of the invention will become apparent in the following text from the description of exemplary embodiments of the invention given with reference to the figures, which depict meridian views of designs of a tyre according to one embodiment of the invention. In order to make them easier to understand, the figures are not shown to scale.

FIG. 1 depicts a meridian section through the inflated tyre, mounted on a rim and compressed by the load carried. A first section in the contact patch and a second section opposite the contact patch in relation to the axis (YY′) can be seen.

FIGS. 2-A and 2-B show modifications to the outer profile of the tyre for facilitating contact with the rim.

FIG. 2-C depicts an enlarged view of a bead of a tyre of the invention installed on a rim.

FIG. 3-A illustrates the determination of the height H of a tyre.

FIG. 3-B depicts the main sides of the bead in line with the invention.

### DETAILED DESCRIPTION OF THE INVENTION

The invention has been implemented on a passenger-vehicle tyre of size 245/45R18 in accordance with the standard of specifications of the ETRTO (European Tyre and Rim Technical Organization). Such a tyre can carry a load of 800 kilos, inflated to a pressure of 250 kPa.

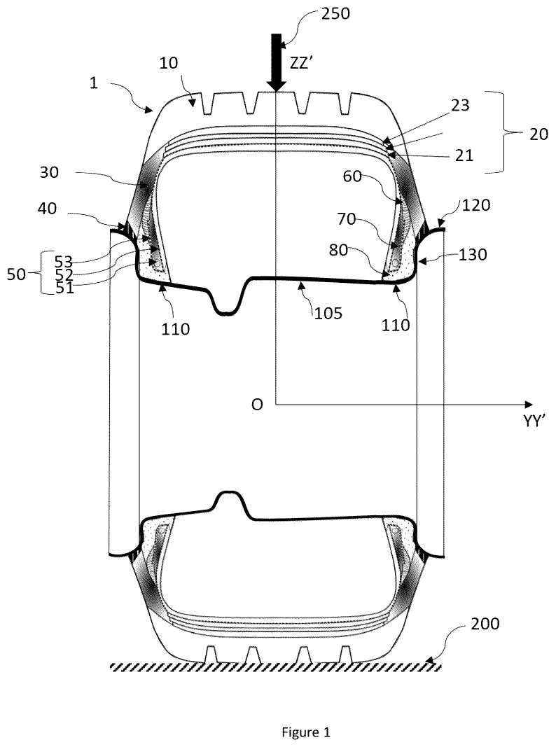

In FIG. 1, the tyre 1 comprises a carcass reinforcement 90 made up of reinforcers coated with rubber composition, and two beads 50 each having annular reinforcing structures 51 which hold the tyre 1 on the rim 100. The carcass reinforcement 90 is anchored in each of the beads 50. The tyre 1 also has a crown reinforcement 20 comprising two working layers 21, 22 and a hooping layer 23. Each of the working layers 21 and 22 is reinforced by filamentary reinforcing elements which are parallel within each layer and crossed from one layer to the other, forming angles between 10° and 70° with the circumferential direction. The hooping layer 23 is disposed radially on the outside of the crown reinforcement 20, this hooping layer 23 being formed of reinforcing elements which are oriented circumferentially and wound in a spiral. A tread 10 is placed radially on the hooping layer 23; it is this tread 10 which provides the contact between the tyre 1 and the ground 100. The tyre 1 depicted is a “tubeless” tyre: it comprises an “inner liner” 95 made of a rubber composition impermeable to the inflation gas, covering the inner surface of the tyre. The tyre is compressed against the ground 200 by a vertical load 250. Each bead 50 comprises a layer of elastomeric compound 80 which is positioned radially furthest on the inside and is intended to be in contact with the rim 100, and a layer of elastomeric filler compound 70 which is positioned at least partially between the main part 52 of the carcass layer 90 and the turn-up 53. The bead 50 also comprises a lateral reinforcing layer 60 axially on the outside of the turn-up 53 and axially on the inside of the sidewall 30.

Still in FIG. 1, the mounting rim 100 extends axially on either side of the vertical axis OZ and comprises at least one profile 105 having, on at least one part delimited by the axis OZ, a seat 110 intended to receive the heel of the tyre, the seat 110 being connected to a rectilinear portion 130 of the rim, the rectilinear portion 130 itself being connected to the flange 120.

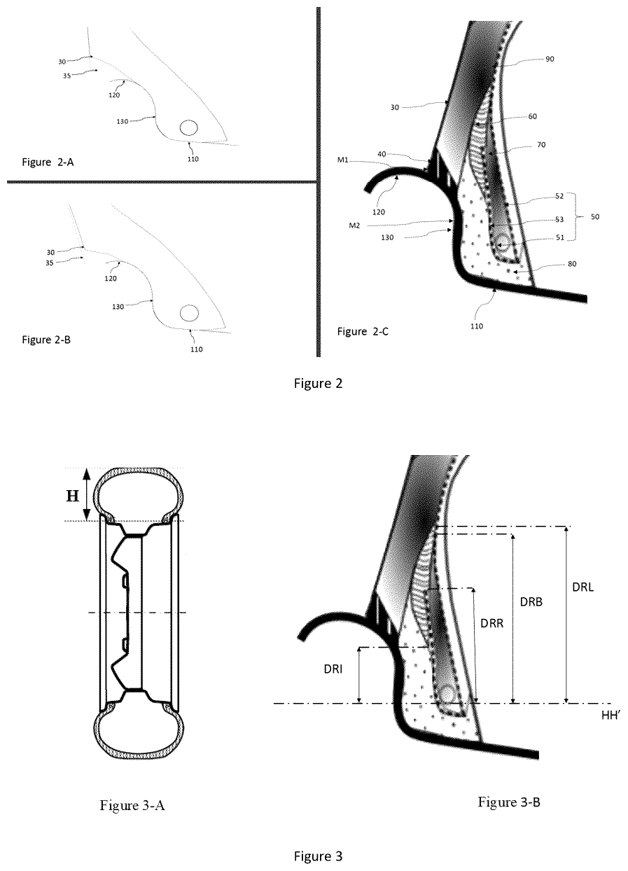

FIG. 2-A depicts the outer profiles of a bead 50 of a tyre 1 of the invention compared with that of a tyre of the prior art. The bead 50 is depicted in a section opposite the contact patch. The two profiles differ in an area at the rim flange 120. The reference 30 indicates the profile of a tyre of the prior art, and the reference 35 shows the modification to the profile that is made on the tyre of the invention to facilitate contact with the rim 100.

FIG. 2-B depicts the same thing as FIG. 2-A, except that the profiles are shown in the centre of the contact patch in which contact is made with the ground. The tyre is in contact with the entire rim flange 120, by contrast to FIG. 2-A. The ratio of the variation in rim contact manifests this evolution in the rim contact.

In the embodiment depicted in FIG. 2-C, there is a cushion of elastomeric compound 40 (modification located at the radially inner end of the sidewall 30) that is intended to be in contact with the rim flange 120. The cushion of compound 40 is delimited radially on the inside by a curve which closely follows the profile of the rim flange 120. A first side of the cushion of elastomeric compound 40 has a suitable geometric shape which anticipates contact with the curvature of the rim flange so as to closely follow the shape of the rim flange 120 when contact is being made, a second side of the cushion of elastomeric compound continues an outer side of a sidewall that is in contact with the ambient air, a third side of the cushion of elastomeric compound 40 is in contact with the radially inner end of the sidewall, and lastly a fourth side of the cushion of elastomeric compound is in contact with the protective layer 80.

In FIG. 2-C, the rim contact curve extends from a first point M1 on the tyre that is positioned axially furthest on the outside, and in contact with the rim, and a second point M2 on the tyre that is also in contact with the rim and is located in the middle of the rectilinear portion connecting the flange 120 to the seat 110 of the rim. The length of this rim contact curve is the curvilinear distance from the point M1 to the point M2 along the rim contact curve.

FIG. 3-A illustrates the determination of the height H. The height H of the tyre is the normal distance between a first straight line which is parallel to the axis of rotation of the tyre and tangent to the radially innermost point of the annular reinforcing structure, and a second straight line which is also parallel to the axis of rotation of the tyre and passes through the radially outermost point of the tread. The radial height H is measured on the tyre mounted on a rim and inflated to a setpoint pressure in accordance with the ETRTO (European Tyre and Rim Technical Organization) specifications.

FIG. 3-B depicts the geometric parameters of the bead in line with the invention. The heights are defined from the straight line HH′, which is tangent to the bead wire 51 at its radially innermost point:

DRI is the radial distance from HH′ of the radially inner end of the lateral reinforcing layer 60. The radial distance DRI is less than or equal to 20% of the radial height H of the tyre, and in the example presented here is 5 mm;

DRL is the radial distance from the straight line HH′ of the radially outer end of the lateral reinforcing layer 60. The radial distance DRL is greater than or equal to 25% of the radial height H of the tyre, and in the example presented here is 38 mm;

DRR is the radial distance from HH′ of the end of the turn-up of the carcass reinforcement 90. The radial distance DRR is greater than or equal to 10% of the radial height H of the tyre, and in the example presented here is 20 mm;

DRB is the radial distance from HH′ of the radially outer end of the filler layer 70, and in the example presented here is 28 mm.

The following Table 1 indicates the compositions of elastomeric compounds of a bead to which the invention relates. The main compounds used are listed, for each of which the main ingredients are expressed in phr (parts by weight per hundred parts by weight of elastomer).

TABLE 1

| | Elastomer | Reinforcing | | | | | |
|---|---|---|---|---|---|---|---|
| | NR | filler - | | | | Rein- | |
| | (Natural | carbon | Anti- | Sul- | Accel- | forcing | Hard- |
| | rubber) | black | oxidant | fur | erator | resin | ener |
| M1 | 100 | 75 (N326) | 1.5 | 8.5 | 0.95 | 12 | 4.18 |
| M2 | 100 | 75 (N326) | 2 | 7.5 | 0.97 | 12 | 6.8 |
| M3 | 100 | 55 (N550) | 1.3 | 9.0 | 0.68 | 0 | 0 |

The compounds of the invention used in this example are based on a natural rubber elastomer and reinforced by carbon black. Plasticizers (reinforcing resin) are incorporated in the composition to facilitate the processability of the compounds. The compounds also comprise vulcanization agents, sulfur, an accelerator, and protection agents. The associated mechanical and viscoelastic properties, measured at 23° C. under a strain amplitude of 10%, are summarized in Table 2:

TABLE 2

| | G′ | G″ | Tan(δ)max |
|---|---|---|---|
| M1 | 46 | 7 | 0.2 |
| M2 | 48 | 8 | 0.2 |
| M3 | 3 | 0.3 | 0.1 |

In the context of the invention, the elastomeric compounds M1 and M2, having an elastic dynamic shear modulus of 46 MPa and 48 MPa, respectively, are referred to as stiff. The compound M3, having a viscoelastic loss equal to 0.1, is referred to as low-hysteresis.

A configuration P1 of the tyre of the invention was tested in order to strongly highlight the performance offered by the invention.

The results of these tyres are compared with those of the controls T1. T2 and T3.

The control T1 corresponds to a tyre of conventional design, comprising a first filler layer located between the main part of the carcass layer and its turn-up. This first filler layer is made of the compound M1. This tyre also comprises a second lateral reinforcing layer positioned between the sidewall layer and the turn-up of the carcass reinforcement. This second lateral reinforcing layer is provided with the elastomeric compound M2. The profile of the sidewall layer was not modified to facilitate contact with the rim, as is the case for the tyres of the invention.

The ratio of the variation in rim contact on the control tyre T1 is conventionally set at 100, that is to say that this ratio of the variation in contact with the rim deviates by less than 30 from a tyre of the invention.

For the configuration T2, the filler layer, and the second lateral reinforcing layer, are made of the same elastomeric compound M3, but the profile of the sidewall, by contrast to the tyres of the invention, has not been modified to facilitate contact with the rim.

As regards the second variant T3, the first filler layer is made of the compound M1, and the second lateral reinforcing layer is provided with the elastomeric compound M2. The profile of the sidewall has this time been modified to facilitate contact with the rim, in accordance with FIGS. 2-A and 2-B.

A tyre variant P1 in accordance with the invention reprises the specifications of the control T1, with the compound of the second filler layer replaced by the compound M3. The ratio of the variation in rim contact is 167 after partial modification of the profile of the sidewall layer in the area of contact with the rim, as depicted in FIGS. 2-A and 2-B.

The control tyres, and the configuration in accordance with the invention, were tested to measure the rolling resistance and the transverse cornering stiffness. These same tyres were also evaluated by the test of mountability on a rim.

Table 3 below summarizes the configurations under consideration:

TABLE 3

| | | | Modification |
|---|---|---|---|
| | | Lateral | to the profile |
| | Filler | reinforcing | of contact |
| | layer | layer | with the rim |
| T1 | M1 | M2 | nok⁽¹⁾ |
| T2 | M3 | M3 | nok⁽¹⁾ |
| T3 | M1 | M2 | ok |
| P1 | M1 | M3 | ok |

⁽¹⁾The term Nok means that the profile of the sidewall layer was not modified to facilitate contact with the rim and ok means that this profile was modified so as to obtain a ratio of the variation in rim contact of greater than 30.

The rolling resistance test was carried out according to the standard ISO 28580. For a tested tyre, the result is the coefficient of rolling resistance, which represents the ratio of the resistance force opposing the forward travel of the vehicle owing to hysteresis of the tyres divided by the load carried.

The transverse cornering stiffness was measured on dedicated measuring machines, such as those sold by MTS.

The test of mountability on a rim consists in giving a result for the overall mountability on the basis of a breakdown of the mounting into elementary operations, which notably comprise: passing through the rim flanges, pressure tapping, crossing of humps on the rim, placing the bead by compression, the tightness below the rim seat, debeading and dismounting. To perform this test, means such as a semi-automatic mounting machine, or else radiography means, are necessary.

The results obtained are summarized in the following Table 4, which also displays the ratio of the variation in rim contact for each variant:

TABLE 4

| | | Transverse | Ratio of the | |
|---|---|---|---|---|
| | Rolling | cornering | variation in | Mountability |
| | resistance | stiffness | rim contact | on rim |
| T1 | 100 | 100 | 100 | 100 |
| T2 | 108 | 97 | 112 | 110 |
| T3 | 96 | 103 | 160 | 95 |
| P1 | 105 | 99 | 167 | 105 |

Observing the results of the tyres, the principle of using a bead with flexible materials, such as the compound M3, to lower the rolling resistance of the tyre is confirmed (T2). However, a concomitant drop in the cornering stiffness can also be observed.

Conversely, these same results teach that when use is made of a stiff bead, that is to say a bead with a first filler layer and a second lateral reinforcing layer made with the elastomeric compounds (M1, M2) respectively, the rolling resistance deteriorates significantly.

The control T3 teaches that the modification of the profile of the sidewall layer for facilitating the rim contact that is associated with a stiff bead improves the transverse cornering stiffness, but deteriorates the mountability on a rim.

The variant P1 exhibits an improvement in rolling resistance. The transverse cornering stiffness drops. The ratio of the variation in rim contact is at a level which makes it possible to limit the drop in transverse corning stiffness. The relative flexibility of the bead linked to the drop in the shear stiffness modulus of the compound M3 of the first filler layer facilitates mountability on a rim.

The variant P1 has a level of transverse cornering stiffness which is approximately identical to the control. Digital simulations are used to confirm that the handling of these variants gives identical results to the control.

All the variants presented are produced without developing the methods and retain an industrial manufacturing cost which is not very different from the usual costs.

Furthermore, the invention can be applied more generally to different bead architectures to those described here, such as a bead having a first filler layer and a second lateral layer, even though the carcass reinforcement does not comprise a turn-up.

1.-10. (canceled)

11. A tire (1) for a passenger vehicle comprising:
two beads (50) intended to be mounted on a rim, two sidewall layers (30) connected to the beads (50), and a crown (20) having a tread (10) intended to come into contact with a ground (200), the crown (20) having a first side connected to a radially outer end of one of the two sidewall layers (30) and a second side connected to a radially outer end of another one of the two sidewall layers (30);
at least one carcass reinforcement (90) extending from the two beads (50) through the sidewall layers (30) as far as the crown (20), the carcass reinforcement (90) having a plurality of carcass reinforcing elements and being anchored in the two beads (50) by way of a turn-up around an annular reinforcing structure (51), so as to form a main part (52) and a turn-up (53) in each bead;
a first layer (70) of elastomeric filler compound taking up a volume which is comprised at least partially between the main part of the carcass reinforcement (52) and a radially outer portion of the annular reinforcing structure (51), and extending radially outwards to an end located at a normal distance DRB from an axial straight line (HH′) which is tangent to the annular reinforcing structure at a radially innermost point;
a second layer (60) of elastomeric compound forming a lateral reinforcing layer (60) taking up a volume comprised at least partially between the sidewall layer (30) and the turn-up (53) of the carcass reinforcement, and extending radially outwards to an end located at a normal 20 distance DRL from the axial straight line HH′ which is tangent to the annular reinforcing structure (51) at the radially innermost point,
wherein a dynamic shear stiffness moduli and a viscoelastic loss of the elastomeric compounds are measured in accordance with standard ASTM D 5992-96, at 100° C., under 10% strain,
wherein, in each bead (50), a rim contact curve comprises points on the tire (1) that are in contact with the rim (100), the rim contact curve connecting a first point M1 on the tire that is positioned axially furthest on an outside, and in contact with the rim, and a second point M2 on the tire that is also in contact with the rim and is located in a middle of a rectilinear portion connecting a flange to a seat of the rim, and a length of the rim contact curve being a curvilinear distance from the point M1 to the point M2 along the contact curve,
wherein there are two sections in a vertical meridian plane of the tire in an inflated state mounted on a rim and compressed against a hard flat ground, by a vertical load (250), where a load and an inflation pressure are at nominal values from an ETRTO standard, a first section being located in the contact patch, and a second section being located on an opposite side to the first section in relation to an axis of rotation of the tire,
wherein, in the first section located in the contact patch, in at least a first bead, a length of the rim contact curve, LADC, is measured,
wherein, in the second section located opposite the contact patch in relation to the axis of rotation of the tire, in at least a second bead, a length of the rim contact curve, LCJ, is measured,
wherein a ratio of the difference in the lengths of the rim contact curves of the two sections, 100*(LADC−LCJ)/LCJ, is greater than or equal to 30, and
wherein the viscoelastic loss Tan(δ)max of the elastomeric compound making up the second lateral reinforcing layer (60) of at least one bead (50) has a value less than or equal to 0.100.

12. The tire (1) according to claim 11, wherein the second lateral reinforcing layer (60) of at least one bead (50) has an elastic shear stiffness modulus that lies within the range 1.5-10 MPa.

13. The tire (1) according to claim 11, wherein the ratio of the difference in the lengths of the rim contact curves of the two sections is greater than or equal to 40.

14. The tire (1) according to claim 11, wherein a radial distance DRB of the first filler layer (70) comprised between the main part (52) of the carcass reinforcement (90) and the turn-up (53) is less than or equal to 50% of the radial height H of the tire (1).

15. The tire (1) according to claim 11, a radial distance DRI being a radial height of a radially innermost end of the lateral reinforcing layer (60) positioned between the sidewall layer (30) and the turn-up (53) of the carcass reinforcement (90), wherein the radial distance DRI lies within the range 5%-20% of the radial height H of the tire (1).

16. The tire (1) according to claim 11, the distance DRL being a distance of the radially outer end of the lateral reinforcing layer (60) positioned between the sidewall layer (30) and the turn-up (53) of the carcass reinforcement (90), wherein the distance DRL is greater than or equal to 25% of the radial height H of the tire (1).

17. The tire (1) according to claim 11, wherein the turn-up (53) of the carcass reinforcement (90) is in contact with the main part (52) of the carcass reinforcement (90) radially on an outside along the turn-up (53).

18. The tire (1) according to claim 11, wherein a reinforcement of the bead (50) is introduced axially on an outside between the turn-up (53) of the carcass 5 reinforcement (90) and the lateral reinforcing layer (60), axially on an inside of the sidewall (30).

19. The tire (1) according to claim 11, wherein the elastomeric compound making up at least one layer of the first and the second layer (60, 70) of at least one bead (50) has a composition on a basis of 100% polyisoprene natural rubber, or a blend of natural rubber and polybutadiene, a crosslinking system, a reinforcing filler of carbon black N550 type, at an overall content of between 50 and 75 phr.

20. The tire (1) according to claim 11, wherein the elastomeric compound making up the filler layer (70) of at least one bead (50) has the same composition as the elastomeric compound making up the lateral reinforcing layer (60) of the bead (50).
